(19) United States
(12) Patent Application Publication
(10) Pub. No.: US 2022/0121983 A1
(43) Pub. Date: Apr. 21, 2022

(54) MULTI-SCALE UNSUPERVISED ANOMALY TRANSFORM FOR TIME SERIES DATA

(71) Applicant: salesforce.com, inc., San Francisco, CA (US)

(72) Inventor: Arun Kumar Jagota, Sunnyvale, CA (US)

(21) Appl. No.: 17/074,928

(22) Filed: Oct. 20, 2020

(51) Int. Cl. G06N 20/00; G06F 16/23

(52) U.S. Cl. CPC G06N 20/00; G06F 16/2379

(57) ABSTRACT

System receives input value in time series and determines first difference between input value at input time, and first value in time series at input time minus first lag. System determines first score based on first difference and both first average and first dispersion for first lag and time series values. System determines second difference between input value at input time, and second value in timeseries at input time minus second lag. System determines second score based on second difference and both second average and second dispersion for second lag and time series values. System transforms first and second scores into normalized anomaly score in normalized anomaly score time series. Time series database system stores normalized anomaly score time series and input value's time series into time series database. If normalized anomaly score satisfies threshold, system outputs alert including normalized anomaly score and input value retrieved from time series database.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### BACKGROUND

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches, which in and of themselves may also be inventions.

Creating and maintaining cloud-based computing platforms can be exceedingly complex, as thousands of computer servers and other resources in geographically disparate locations may serve billions of customer-initiated requests daily on a global scale. Millions of applications may run on these servers on behalf of customers, either directly or indirectly. These customers want all their requests and applications to execute correctly, quickly, and efficiently. An application slow-down, or even worse, a resource unavailability, can cause a customer to lose money, which may cause the platform provider to lose the customer. Customers typically expect resource availability to be 99.99+percent. Beyond resource availability, customer satisfaction is adversely impacted if services run slower than customer expectations.

In view of the complexity of these challenges, combined with the stringency of these requirements, a new specialty field developed, which may be referred to as application performance monitoring or computer performance monitoring. Application performance monitoring helps cloud-based computing vendors to detect and diagnose disruptions in the performance of their services and applications. Some application performance monitoring solutions can continuously monitor hundreds of millions of metrics, in the form of a time series, for potential issues.

A time series can be a sequence of data points that may be indexed, listed, and/or graphed in a chronological time order. Most commonly, a time series is a sequence of discrete values recorded at successive equally spaced points in time. Many domains of applied science and engineering which involve temporal measurements use time series. Time series analysis includes methods for analyzing time series in order to extract meaningful statistics and other characteristics from the values. Time series forecasting is the use of models to predict future values based on previously observed values. The implementation of a computerized database system that can correctly, reliably, and efficiently implement such methods and forecasts must be specialized for processing time series values.

Many metrics may be monitored because hundreds of thousands of computing resources can each generate multiple metrics that measure various aspects of each resource's health. Additionally, these metrics may measure various aspects of the health of the millions of application instances that execute on servers. Some of these metrics can track the response times (over time) of various application services from tests originating from geographically dispersed regions. Furthermore, all of this monitoring may be done on a tenant-specific basis. Monitoring hundreds of millions of metrics simultaneously for potentially anomalous behavior in any metric can be a significant challenge, both in terms of scale, and in anomaly detection accuracy. While a system administrator may prefer to discover all significant anomalous behaviors as early as possible, overly sensitive anomaly detection can yield many false alarms which may cost software developers and support engineers substantial amounts of wasted efforts.

### BRIEF DESCRIPTION OF THE DRAWINGS

In the following drawings like reference numbers are used to refer to like elements. Although the following figures depict various examples, the one or more implementations are not limited to the examples depicted in the figures.

FIG. 1 is an example graph for calculating time series anomaly scores by using a multi-scale unsupervised anomaly transform for time series data, in an embodiment;

FIG. 2 is an operational flow diagram illustrating a high-level overview of a method for a multi-scale unsupervised anomaly transform for time series data, in an embodiment;

FIG. 3 illustrates a block diagram of an example of an environment wherein an on-demand database service may be used; and

FIG. 4 illustrates a block diagram of an embodiment of elements of FIG. 3 and various possible interconnections between these elements.

### DETAILED DESCRIPTION

### General Overview

In accordance with embodiments described herein, there are provided systems and methods for a multi-scale unsupervised anomaly transform for time series data. A system receives an input value in a time series, and determines a first difference between the input value, corresponding to an input time, and a first value in the time series, corresponding to the input time minus a first lag. The system determines a first score based on the first difference and both a first average and a first dispersion corresponding to the first lag and values in the time series. The system determines a second difference between the input value, corresponding to the input time, and a second value in the time series, corresponding to the input time minus a second lag. The system determines a second score based on the second difference and both a second average and a second dispersion corresponding to the second lag and the values in the time series.

The system transforms the first score and the second score into a normalized anomaly score in a time series for normalized anomaly scores. A time series database system stores the time series for normalized anomaly scores and the time series comprising the input value into a time series database. If the normalized anomaly score satisfies a threshold, the system outputs an anomaly alert comprising information about the normalized anomaly score and the input value retrieved from the time series database.

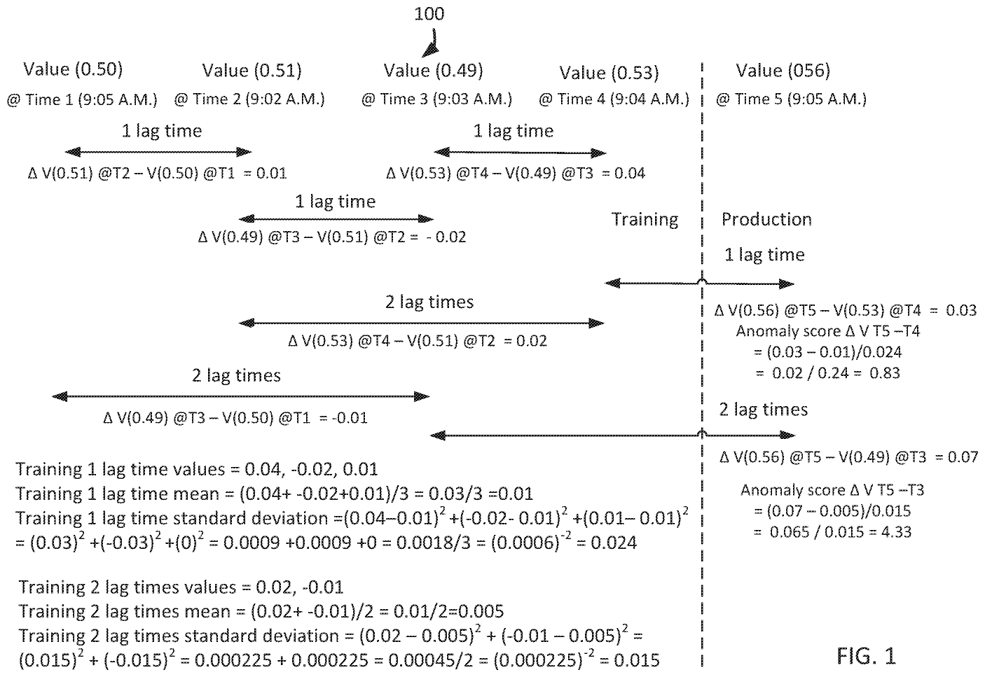

FIG. 1 depicts an example graph for calculating time series anomaly scores, in which an anomaly scoring system receives a time series value of 56% cloud memory utilization at 9:05 A.M, and calculates a difference of 3% between the 56% cloud memory utilization at 9:05 A.M. and the 53% cloud memory utilization at one minute, or 1-lag time, earlier at 9:04 A.M. The anomaly scoring system calculates a 1-lag time, or 1-time scale, score of 0.83 for the new value of 56% cloud memory utilization by subtracting the training mean of 1% cloud memory utilization for a 1-minute time scale from the difference of 3% cloud memory utilization, and then dividing the result of 2% cloud memory utilization by the training standard deviation of 2.4% for the 1-minute time scale. Then the anomaly scoring system calculates a difference of 7% between the 56% cloud memory utilization at 9:05 A.M. and the 49% cloud memory utilization at two minutes, or 2 lag times, earlier at 9:03 A.M. The anomaly scoring system calculates a 2-lag times, or 2-time scales, score of 4.33 for the new value of 56% cloud memory utilization by subtracting the training mean of 0.5% cloud memory utilization for a 2-minutes time scale from the difference of 7% cloud memory utilization, and then dividing the result of 6.5% cloud memory utilization by the training standard deviation of 1.5% for the 2-minutes time scale.

The anomaly scoring system identifies 4.33, corresponding to the greatest absolute value of the 1-time scale score and the 2-time scales score, as the normalized anomaly score for the 56% cloud memory utilization at 9:05 A.M. A time series database system stores the normalized anomaly score time series, which includes the normalized anomaly score of 4.33, and the cloud memory utilization time series, which includes the input value of 56%, into a time series database. Since the normalized anomaly score of 4.33 satisfies the threshold of 3 standard deviations, the system outputs an anomaly alert that identifies the normalized anomaly score of 4.33 and the 56% cloud memory utilization, which are retrieved from the time series database. Although the increase of 3% cloud memory utilization from 9:04 A.M. to 9:05 A.M. resulted in a score of 0.83 that is not enough to be considered as an anomaly because it does not exceed a threshold of 3 standard deviations, the increase of 7% cloud memory utilization from 9:03 A.M. to 9:05 A.M. resulted in a score of 4.33 that is enough to be considered as an anomaly because it exceeds the threshold of 3 standard deviations.

Systems and methods are provided for a multi-scale unsupervised anomaly transform for time series data. As used herein, the term multi-tenant database system refers to those systems in which various elements of hardware and software of the database system may be shared by one or more customers. For example, a given application server may simultaneously process requests for a great number of customers, and a given database table may store rows for a potentially much greater number of customers. As used herein, the term query plan refers to a set of steps used to access information in a database system. The following detailed description will first describe a multi-scale unsupervised anomaly transform for time series data. Next, methods for a multi-scale unsupervised anomaly transform for time series data will be described with reference to example embodiments.

While one or more implementations and techniques are described with reference to an embodiment in which a multi-scale unsupervised anomaly transform for time series data are implemented in a system having an application server providing a front end for an on-demand database service capable of supporting multiple tenants, the one or more implementations and techniques are not limited to multi-tenant databases nor deployment on application servers. Embodiments may be practiced using other database architectures, i.e., ORACLE®, DB2® by IBM and the like without departing from the scope of the embodiments claimed.

Any of the embodiments described herein may be used alone or together with one another in any combination. The one or more implementations encompassed within this specification may also include embodiments that are only partially mentioned or alluded to or are not mentioned or alluded to at all in this brief summary or in the abstract. Although various embodiments may have been motivated by various deficiencies with the prior art, which may be discussed or alluded to in one or more places in the specification, the embodiments do not necessarily address any of these deficiencies. In other words, different embodiments may address different deficiencies that may be discussed in the specification. Some embodiments may only partially address some deficiencies or just one deficiency that may be discussed in the specification, and some embodiments may not address any of these deficiencies.

An anomaly scoring system can detect anomalies in any time series data values or metrics. Designed specifically for monitoring and alerting on time series, the anomaly scoring system does not make final decisions on which time series values are anomalous and which time series values are normal. Rather, the anomaly scoring system inputs time series values and uses the input time series values to derive a new time series that has anomaly scores as its values and which a time series database system stores in the time series database that stores the input time series values. A time series database can be a structured set of information which includes sequences of data points that may be indexed, listed, and/or graphed in chronological time orders. A time series database system can be the computer hardware and/or software that stores and enables access to sequences of data points that may be indexed, listed, and/or graphed in chronological time orders.

This approach empowers multiple use cases of anomaly detection in the performance monitoring setting. The anomaly scoring system can enable the visualization of time series of such anomaly scores for historical analysis. The anomaly scoring system can trigger anomaly alerts when anomaly scores reach certain thresholds. These thresholds are easier for system users to select for the anomaly scores than thresholds would be to select for the values in the input time series. This ease in selecting thresholds is due to the anomaly scoring system intelligently using relative values to generate anomaly scores that reflect the likelihood that these relative values are anomalies, and normalizing the anomaly scores, which are agnostic to the ranges of the actual values in the original time series.

An anomaly alert can be an announcement that warns about a value which deviates from what is standard, normal, or expected. A normalized anomaly score can be a rating or a grade of a value's deviation from what is standard, normal, or expected, with the rating or grade being reduced to a standard. A threshold can be the magnitude that must be satisfied for a certain result or condition to occur.

The anomaly scoring system identifies spikes, dips, and sharp trend changes relative to the established usual behavior of a time series' values and embodies a unique blend of unsupervised and supervised functioning. The anomaly scoring system can identify anomalies in any input time series, without any human training, and therefore may be unsupervised. This capability of functioning unsupervised is important in a system which can monitor millions of time series, such that human training of the anomaly scoring system on each individual time series is not feasible. However, when users want to set anomaly alerts on the time series of anomaly scores, the users can select any combination of individualized and grouped thresholds, such as a threshold of 3 standard deviations for the anomaly scores of cloud memory utilization values, and a threshold of 2.5 standard deviations for the anomaly scores of cloud CPU utilization values. This way, users can control the precision and recall of the identified anomalies given the users' domain knowledge of the corresponding input time series.

To gain accuracy, the anomaly scoring system builds sophisticated models that can employ statistics-based machine learning. However, these models can be built within the constraints that the anomaly scoring system trains very quickly with a training set of training values to calculate a training anomaly score, and trains itself continuously and incrementally as new values of the time series are input. By contrast, most high-powered machine learning systems involve offline batch training which is typically relatively slow. The anomaly scoring system can build normalcy models for multiple time scales, with each time scale equated to a corresponding lag of time. The anomaly scoring system determines that a new value in a time series is anomalous if the new value is unusual relative to that of the values modeled by at least one time scale's normalcy model. A machine learning system can be an artificial intelligence tool that has the ability to automatically learn and improve from experience without being explicitly programmed. A lag can be a period of time between recording one value and recording another value.

Let x₁, x₂, . . . xₜ, . . . denote a time series. FIG. 1 depicts an example of the x values at the times t=1 to 4 in a training set of time series as 0.50@9:01 A.M., 0.51@9:02 A.M., 0.49@9:03 A.M., and 0.53@9:04 A.M. A value can be the numerical amount denoted by an algebraic term, a magnitude, quantity, or number. A time can be a clearly identified chronological point as measured in hours and minutes past midnight or noon. A training set can be a collection of distinct entities regarded as a unit which is used for teaching by practice and/or instruction.

Let Δ_{k,t} ≡xₜ−xₜ₋ₖ. FIG. 1 depicts an example of the time scale k=1 minute or 1-lag time, for differences between the x values at the times t=1 to 4 in a training set of time series (which are the difference between the values for times 4 and 3, the difference between the values for times 3 and 2, and the difference between the values for times 2 and 1) as ΔV(0.53)@T4−V(0.49)@T3=0.04; ΔV(0.49)@T3−V(0.51)@T2=−0.02; and ΔV(0.51)@T2−V(0.50)@T1=0.01. FIG. 1 also depicts an example of the time scale k=2 minutes, or 2-lag times, for differences between the x values at the times t=1 to 4 in a training set of time series (which are the difference between the values for times 4 and 2, and the difference between the values for times 3 and 1) as ΔV(0.53)@T4−V(0.51)@T2=0.02 and ΔV(0.49)@T3−V(0.50)@T1=−0.01. A difference can be the remainder left after subtraction of one value from another value.

To simplify notation, let Δ_{0,t}=xₜ. FIG. 1 depicts an example of the time scale k=0 minutes, or 0-lag time, for differences between the x values at the times t=1 to 4 in a training set of time series (which are the values for times 1, 2, 3, and 4) as 0.50@9:01 A.M., 0.51@9:02 A.M., 0.49@9:03 A.M., and 0.53@9:04 A.M.

The anomaly scoring system is parametrized by a sequence of time scales or lag times K=0, k₁, k₂, . . . , with the primary focus on the exponentially expanding sequence K=0, 1, 2, 4, 8, 16, . . . , such that a wide range of time scales or lag times is covered by a short sequence. As described above, FIG. 1 depicts an example of the time scales, or lag times, k=1, 2 for differences between the x values at the times t=1 to 4 in a training set of time series.

The normalcy model for any kϵK is described by statistics that represent an average and a dispersion of the differences between values, such as the mean (mₖ) and the standard deviation (sₖ). An average can be a number expressing the central or typical value in a set of data, in particular the mode, median, or (most commonly) the mean, which is calculated by dividing the sum of the values in the set by the count of the values in the set. A dispersion can be the extent to which values differ from a fixed value, such as the mean.

FIG. 1 depicts an example of calculating the time scale, or lag time, k=1 mean (mₖ) for the differences between the x values at the times t=1 to 4 in a training set of time series, as the average of the differences between the training 1 lag time values of 0.04, −0.02, and 0.01, which equals (0.04+−0.02+0.01)/3=(0.03)/3=0.01, which is the training 1 lag time mean. FIG. 1 also depicts an example of calculating the time scale, or lag time, k=1 standard deviation (sₖ) for the differences between the x values at the times t=1 to 4 in a training set of time series. Calculating the standard deviation (sₖ) requires calculating the sum of the square of the differences in the values minus the mean, which is (0.04−0.01)²+(−0.02−0.01)²+(0.01−0.01)²=(0.03)²+(−0.03)²+(0)²=0.0009+0.0009+0=0.0018, calculating the average of this sum, which is 0.0018/3=0.0006, then taking the square root of this average, which is (0.0006)^{(1/2)}=0.024.

FIG. 1 additionally depicts an example of calculating the time scale, or lag time, k=2 mean (mₖ) for the differences between the x values at the times t=1 to 4 in a training set of time series, as the average of the differences between the training 2 lag times values of 0.02 and −0.01, which equals (0.02+−0.01)/2=0.01/2=0.005, which is the training 2 lag times mean. FIG. 1 further depicts an example of calculating the time scale, or lag time, k=2 standard deviation (sₖ) for the differences between the x values at the times t=1 to 4 in a training set of time series, by calculating the sum of the square of the differences in the values minus the mean, which is (0.02−0.005)²+(−0.01−0.005)²=(0.015)²+(−0.015)²=0.000225+0.000225=0.00045, calculating the average of this sum, which is 0.00045/2=0.000225, then taking the square root of this average, which is (0.000225)^{(1/2)}=0.015.

The anomaly scoring system can be initially trained from an initial prefix of the time series in which the (future) anomalies are sought. This prefix may be denoted as x₁, x₂, . . . xₚ. FIG. 1 depicts an example of the x values at the times p=1 to 4 in a training set of time series, as 0.50@9:01 A.M., 0.51@9:02 A.M., 0.49@9:03 A.M., and 0.53@9:04 A.M.

Noise may be added to each time series value to regularize the training set. Specifically, y₁, y₂, . . . yₚ can be derived from x₁, x₂, . . . xₚ, where yᵢ=xᵢ*(1+ϵ₁)+ϵ₂, where ϵ₁ and ϵ₂ are independent random variables, such as independent gaussian random variables, each with the mean of zero, and with the variance v₁ and v₂, respectively. The anomaly scoring system can use the independent random variables to distort x₁ to a data value that is a bit higher or lower and use ϵ₂ specifically to cover instances when x₁ is 0. To demonstrate the benefit from this added noise or distortion in an extreme, albeit realistic, case, suppose x₁=x₂= . . . =xₚ. Without this added noise or distortion, all the xᵢ values, all the means mₖ, and all the standard deviations sₖ would be 0, which will cause problems in a scoring equation which divides by the result of the value minus the mean by the standard deviation (see Equation 3 below). Adding this noise or distortion to time series values will avoid such a difficulty, as demonstrated by the example below in which if x₁₋₄=0. An independent random variable can be an algebraic term that has equal chances of being each possible value in a range of values and which does not have any effect on any other such algebraic terms. To estimate the parameters from y₁, y₂, . . . yₚ, a sample {Δ_{k,t}} is derived for each kϵK. The parameters mₖ and sₖ of model k are then set to the mean and the standard deviation of this sample.

Consequently, at least some values in the training set may be regularized by additions of corresponding independent random variables and multiplications based on other corresponding independent random variables. In an example if x₁₋₄=1, ϵ₁=0.1, 0.8, −0.5, −0.4, and ϵ₂=−0.3, −0.6, 0.7, 0.2, then y₁=x₁*(1+ϵ₁)+ϵ₂=1*(1.1)+−0.3=1.1+−0.3=0.8; y₂=x₂*(1+ϵ₁)+ϵ₂=1*(1.8)+−0.6=1.8+−0.6=1.2; y₃=x₃*(1+ϵ₁)+ϵ₂=1*(0.5)+0.7=0.5+0.7=1.2; and y₄=x₄*(1±ϵ₁)+ϵ₂=1*(0.6)+0.2=0.6+0.2=0.8. The mean of y₁₋₄=(0.8+1.2+1.2+0.8)/4=4.0/4=1.0. The standard deviation of y₁₋₄ is calculated by calculating the sum of the square of the differences in the values minus the mean, which is (0.8−1.0)²+(1.2−1.0)²+(1.2−1.0)²+(0.8−1.0)²=(−0.2)²+(0.2)²+(0.2)²+(−0.2)²=0.04+0.04+0.04+0.04=0.16, calculating the average of this sum, which is 0.16/4=0.04, then taking the square root of this average, which is (0.04)^{(1/2)}=0.20. Since the standard deviation is not zero, the anomaly scoring system can use a scoring equation which divides by the result of the value minus the mean by the standard deviation, such as Equation 3 below.

In an example if x₁₋₄=0, ϵ₁=0.1, 0.8, −0.5, −0.4, and ϵ₂=−0.3, −0.6, 0.7, 0.2, then y₁=x₁*(1+ϵ₁)+ϵ₂=0*(1.0+−0.3=0+−0.3=−0.3; y₂=x₂*(1+ϵ₁)+ϵ₂=0*(1.8)+−0.6=0+−0.6=−0.6; y₃=x₃*(1+ϵ₁)+ϵ₂=0*(0.5)+0.7=0+0.7=0.7; and y₄=x₄*(1+ϵ₁)+ϵ₂=0*(0.6)+0.2=0+0.2=0.2. The mean of y₁₋₄=(−0.3+−0.6+0.7+0.2)/4=0.0/4=0.0. The standard deviation of y₁₋₄ is calculated by calculating the sum of the square of the differences in the values minus the mean, which is (−0.3−0.0)²+(−0.6−0.0)²+(0.7−0.0)²+(0.2−0.0)²=(−0.3)²+(−0.6)²+(0.7)²+(0.25)²=0.09+0.36+0.49+0.04=0.98, calculating the average of this sum, which is 0.98/4=0.245, then taking the square root of this average, which is (0.245)^{(1/2)}=0.49. Since the standard deviation is not zero, the anomaly scoring system can use a scoring equation which divides by the result of the value minus the mean by the standard deviation, such as Equation 3 below.

Alternatively, the anomaly scoring system can train on the prefix training set x₁, x₂, . . . xₚ, without using independent random variables to regularize the training set. The anomaly scoring system may either bypass calculating any scores when the standard deviation equals zero or use a placeholder score, such as none or null, when the standard deviation equals zero.

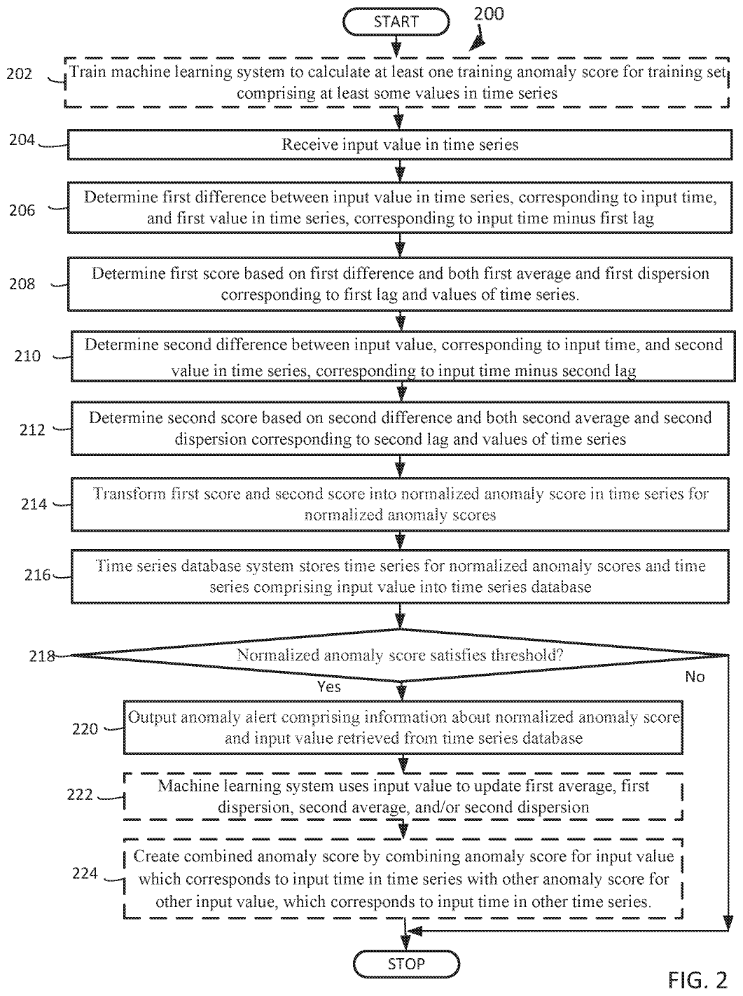

During the initial training, the anomaly scoring system can train to use a training set of time series to calculate a score of a value for each time scale or lag time and then calculate a training anomaly score based on the scores of the value for each time scale or lag time. An example of the anomaly scoring system calculating a training anomaly score is described below in reference to block 202 in FIG. 2. A score can be a rating or a grade. A training anomaly score can be a rating or a grade of a value's deviation from what is standard, normal, or expected, and which is used for teaching by practice and/or instruction.

Once the initial training is done, the anomaly scoring system scores each input value at a corresponding input time, which is each newly arriving time-series value, at each time scale or lag time for being anomalous, and can immediately use each value that is scored to incrementally train the corresponding time scale k models. The anomaly scoring system computes, for each kϵK, Δ_{k,t}=xₜ−xₜ₋ₖ. FIG. 1 depicts an example of the time scale, or lag time, k=1 minute for the difference between the x values at the times t=4 and 5 in a time series (which is the difference between the values for times 5 and 4) as ΔV(0.56)@T5−V(0.53)@T4=0.03. FIG. 1 also depicts an example of the time scale, or lag time, k=2 minutes for the difference between the x values at the times t=3 and 5 in a time series (which is the difference between the values for times 5 and 3) as ΔV(0.56)@T5−V(0.49)@T4=0.07. An input value can be the numerical amount denoted by an algebraic term, a magnitude, quantity, or number, which is received by a computer system. An input time can be a clearly identified chronological point as measured in hours and minutes past midnight or noon, which is received by a computer system.

To be able to compute the difference in values for each kϵK, at any time point, the anomaly scoring system retains the last k* values of x, where k*=max K. This sequence of data values is denoted as Yₖ*=xₜ₋₁, xₜ₋₂, . . . xₜ₋ₖ*. Effectively, this means that each time scale k model is not only a collection {(mₖ, sₖ)\kϵK}, but also contains Y_{k*}. For example, the anomaly scoring system would retain at least the most recent 8 values of x if the maximum time scale K was 8, at least the most recent 16 values of x if the maximum time scale K was 16, at least the most recent 32 values of x if the maximum time scale K was 32, at least the most recent 65 values of x if the maximum time scale K was 64, at least the most recent 128 values of x if the maximum time scale K was 128, etc.

Next, the anomaly scoring system calculates time scale-specific anomaly scores for xₜ. The time scale-k anomaly score of xₜ is defined as

zₖ(Δ_{k,t})=(Δ_{k,t}−mₖ)/sₖ (Equation 1)

FIG. 1 depicts an example of the anomaly scoring system calculating a score for the time scale, or lag time, k=1 minute for the difference between the x values at the times t=4 and 5 in a time series, by first subtracting 0.01, which is the training set's mean mₖ for the time scale, or lag time, k=1 minute, from 0.03, which is the difference between the x values at the times t=4 and 5, thereby resulting in the remainder of 0.02. Then the anomaly scoring system divides the remainder of 0.02 by 0.024 which is the training set's standard deviation sₖ for the time scale, or lag time, k=1, thereby resulting in the time scale, or lag time, k=1 score of 0.83 for the new value of 0.56 at time t=5.

FIG. 1 also depicts an example of the anomaly scoring system calculating a score for the time scale, or lag time, k=2 minutes for the difference between the x values at the times t=3 and 5 in a time series, by first subtracting 0.005, which is the training set's mean mₖ for the time scale, or lag time, k=2 minutes, from 0.07, which is the difference between the x values at the times t=3 and 5, thereby resulting in the remainder of 0.065. Then the anomaly scoring system divides the remainder of 0.065 by 0.015, which is the training set's standard deviation sₖ for the time scale, or lag time, k=2 minutes, thereby resulting in the time scale, or lag time, k=2 score of 4.33 for the new value of 0.56 at time t=5.

FIG. 1 depicts an example of the x values at the times p=1 to 4 in a training set of time series, as 0.50@9:01 A.M., 0.51@9:02 A.M., 0.49@9:03 A.M., and 0.53 @9:04 A.M. Although not depicted in FIG. 1, the mean of the x values at the times p=1 to 4=(0.50+0.51+0.49+0.53)/4=2.03/4=0.5075, and the standard deviation of the x values at the times p=1 to 4 is calculated by calculating the sum of the square of the differences in the values minus the mean, which is (0.50-0.5075)²+(0.51-0.5075)²+(0.49−0.5075)²+(0.53−0.5075)=(0.0075)²+(0.0025)²+(−0.0175)²+(0.0225)²=0.000056+0.000006+0.000306+0.000506=0.000874, calculating the average of this sum, which is 0.000874/4=0.0002185, then taking the square root of this average, which is (0.0002185)^{(1/2)}=0.015. The anomaly scoring system can calculate a score for the time scale, or lag time, k=0 minute for the x value 0.56 at the time t=5 in a time series by first subtracting 0.5075, which is the training set's mean mₖ for the time scale, or lag time, k=0 minute, thereby resulting in the remainder of 0.0525. Then the anomaly scoring system divides the remainder of 0.0525 by 0.015 which is the training set's standard deviation sₖ for the time scale, or lag time, k=0, thereby resulting in the time scale, or lag time, k=0 score of 3.50 for the new value of 0.56 at time t=5.

Finally, the anomaly scoring system calculates the overall anomaly score for xₜ from the scale-specific scores

k′=argmax_{kϵK}|zₖ(Δ_{k,t})| (Equation 2)

Z(xₜ)=z_{k′}(Δ_{k′,t}) (Equation 3)

First, the anomaly scoring system uses Equation 2 to find the time scale k′ with the highest absolute value of its time scale anomaly score for xₜ. Next, the anomaly scoring system uses Equation 3 to set the xₜ's overall anomaly score to this time scale's anomaly score, which may be positive or negative. For example, the anomaly scoring system calculates a score of 0.83 for the time scale, or lag time, k=1 for the new value of 0.56 at time t=5, a score of 4.33 for the time scale, or lag time, k=2 for the new value of 0.56 at time t=5, and a score of 3.50 for the time scale, or lag time, k=0 for the new value of 0.56 at time t=5. Therefore, the anomaly scoring system identifies 4.33 as the largest of the absolute values of the time scale scores 0.83, 4.33, and 3.50, and consequently calculates an anomaly score of 4.33 for the new value of 0.56 at time t=5. If the largest of the absolute values of the previously calculated scores was the absolute value of a negative score, then the anomaly scoring system would select the negative score as the anomaly score. Although this example describes the identification of the largest of the absolute values of the time scale scores to determine the corresponding time scale score as the anomaly score, the anomaly scoring system can use other criteria to determine the anomaly score, such as the average of the two largest positive time scale scores or the average of the two smallest negative time scale scores, depending upon which average has the greatest absolute value. An anomaly score can be a rating or a grade of a value's deviation from what is standard, normal, or expected.

The anomaly scoring system can trigger anomaly alerts when anomaly scores reach certain thresholds. For example, the anomaly scoring system triggered an anomaly alert because the increase of 7% cloud memory utilization from 9:03 A.M. to 9:05 A.M. resulted in a anomaly score of 4.33 that is enough to be considered as an anomaly because it exceeds the threshold of 3 standard deviations for cloud memory utilization.

In addition to determining whether the anomaly score for the new value triggered an anomaly alert, the anomaly scoring system can update the time scale k models to account for this new value. To incrementally train on xₜ, for each kϵK, the anomaly scoring system incrementally updates mₖ and sₖ using the new value Δ_{k,t}. In a variant of this, the anomaly scoring system incrementally updates mₖ and sₖ only if |zₖ(Δ_{k,t})|<=Θ, with Θ=a number of the standard deviations, such as a user-specified 3 standard deviations. The premise behind this variant is that if the anomaly scoring system determines that xₜ is anomalous at time scale k, then the anomaly scoring system does not use xₜ to contribute to time scale k's normalcy model.

Consequently, the machine learning system may update the first average and the first dispersion if the first difference is within a number of the first dispersions of the first average, and update the second average and the second dispersions if the second difference is within a number of the second dispersion of the second average. For example, the machine learning system uses the value 0.56 at time t=5 to update the model corresponding to the time scale, or lag time, k=1 because the corresponding score of 0.83 for the time scale, or lag time, k=1 is within 1 standard deviation of the mean for the time scale, or lag time, k=1. In a contrasting example, the machine learning system does not use the value 0.56 at time t=5 to update the model corresponding to the time scale, or lag time, k=2 because the corresponding score of 4.33 for the time scale, or lag time, k=2 is not within 3 standard deviations of the mean for the time scale, or lag time, k=2. To complete the incremental training, the anomaly scoring system adds xₜ to the front of Y_{k*} and deletes the value at the back of Y_{k*}. A number can be an arithmetical value representing a particular quantity and used in counting and making calculations.

The initial training ensures that the time scale k models reflect enough data to be at least reasonably accurate at calculating anomaly scores, then the incremental training ensures the time scale k models adapt quickly to changing conditions, such as to each new normal behavior of a time series values. After receiving a new value x, the anomaly scoring system incrementally updates mₖ according to the following equation: mₖ=mₖ+(x−mₖ)/n, where n is the sample size for mₖ prior to the update, and then the anomaly scoring system increments n by 1. Consequently, a machine learning system may use the input value to update the first average, the first dispersion the second average, and/or the second dispersion. For example, as described above, the training 1 lag time mean m₁=0.01 for a sample size of n=4 values, and the new value for x₅₋₄=0.03. Therefore, the anomaly scoring system incrementally updates mₖ by using the equation mₖ=mₖ+(x−mₖ)/n=0.01+(0.03−0.01)/4=0.01+(0.02)/4=0.01+0.005=0.015 as the new mean m₁. To confirm that this equation's calculations are correct, the training set's differences for m₁ are 0.04, −0.02, and 0.01, and the new difference for m₁ is 0.03. The mean of these differences is calculated as (0.04+−0.02+0.01+0.03)/4=0.06/4=0.015. This incremental update equation for the mean may not appear to result in a significant increase in computational efficiency when applied to a sample size of 4 values. However, the increased efficiency may be more evident when applied to a sample size of 32, 64, or 128 values, because the incremental update equation for the mean enables the anomaly scoring system to save both storage space and computational efforts by not having to store all 32, 64, or 128 previous differences and use each of these individual differences to calculate the updated mean.

The anomaly scoring system can also incrementally update the standard deviation sₖ. In addition to mₖ, the anomaly scoring system can track the running mean of x², denoted as mₖ(x²). When a new value x is encountered, first the anomaly scoring system updates the mean mₖ, as described above, and the mean mₖ(x²). Next, the anomaly scoring system increments n by 1. Now, to compute sₖ at any time, the anomaly scoring system uses the formula vₖ=mₖ(x²)−(mₖ)² For example, since the training set now includes 4 x values for the time scale mₗ, which are 0.04, −0.02, 0.01, and 0.03, the squares of these 4 x values for m₁ are (0.04)², (−0.02)², (0.01)², and (0.03)², which equal 0.0016, 0.0004. 0.0001, and 0.0009, respectively. Consequently, the running mean of the squares of these 4 x values for m₁ is (0.0016+0.0004+0.0001+0.0009)/4=0.003/4=0.00075, which is denoted as m₁(x²). Upon receiving the new value for x₅₋₄=0.03, the anomaly scoring system incrementally updates the mean m₁ as 0.015, as described above, and then incrementally updates the standard deviation using the formula sₖ=(mₖ(x²)−(mₖ)²)^{(1/2)}=(0.00075−(0.015)²)^{(1/2)}=(0.00075−0.000225)^{(1/2)}=(0.000525)^{(1/2)}=0.023, which is a slight reduction in the training set's previous standard deviation of 0.024.

To confirm that this equation's calculations are correct, the training set's differences for m₁ are 0.04, −0.02, and 0.01, and the new difference for m₁ is 0.03. The mean of these differences is calculated as (0.04+−0.02+0.01+0.03)/4=0.06/4=0.015. Therefore, the standard deviation for m₁ of the x values at the times t=1 to 5 is calculated by calculating the sum of the square of the differences in the values minus the mean, which is (0.04−0.015)²+(−0.02−0.015)²+(0.01−0.015)²+(0.03−0.015)²=(0.025)²+(−0.035)²+(−0.005)²+(0.015)²=0.000625+0.001225+0.000025+0.000225=0.002100, calculating the average of this sum, which is 0.0021/4=0.000525, then taking the square root of this average, which is (0.000525)^{(1/2)}=0.023.

The anomaly scoring system can score a combination of time series to reflect correlated anomalies in the time series. The premise is that when something goes wrong in a system and results in one time series value's anomaly score meeting a threshold, often multiple things go wrong in the system around the same time, such that other time series value's anomaly scores meet other thresholds. The anomaly scoring system inputs multiple time series X₁, X₂, . . . Xₙ, all on the same time points, and then outputs a time series Y capturing the combined anomaly scores, or the correlated anomalies scores, at various time points. Therefore, Yₜ is high if there were anomalies in one or more X's at time t or slightly before time t. A combined anomaly score can be a group of ratings or grades of values' deviations from what is standard, normal, or expected. Consequently, the anomaly scoring system can create a combined anomaly score by combining the anomaly score for the input value which corresponds to the input time in the time series with another anomaly score for another input value which corresponds to the input time, in another time series, For example. the anomaly scoring system combines the anomaly score of 4.33 for the new value of 0.56% cloud memory utilization at time 9:05 A.M. with an anomaly score of 3.95 for a new value of 0.55% cloud CPU utilization at time 9:05 A.M. to produce a combined anomaly score of 8.28 for cloud resource utilization at time 9:05 A.M. Although this example describes the addition of two anomaly scores, a combined anomaly score may be based on any types of combination (such as any grouping of averaging, multiplying, adding and multiplying, and/or maximizing two or more anomaly scores) for any number of anomaly scores.

Let z_{i.t} denote the anomaly score as defined in Equation 3 depicting how anomalous x_{i.t} is relative to its previous data values X_{i.t-1}, X_{i.t-2}, . . . X_{i.1}, where z_{i.t} is a time series. The correlated anomalies score, also expressed as a time series, may be based on the various z_{i.t} scores

Zₜ=ΣᵢΣₖKₖσ(a|z_{i,t-k}|−b) (Equation 4)

Here Kₖ is a dampening function, such as a kernel function, which calculates how quickly anomalies detected in the recent past, such as the time t−k, damp out in their contributions to Zₜ. σ(x)=1/(1+e^{-x}) is the sigmoid function whose gain a and offset b may be chosen suitably so as to get the step-like behavior that |z| greater than 2 (or 3) standard deviations should generate an output value close to 1, and |z| less than 2 (or 3) standard deviations should generate an output value close to 0. A dampening function can be a equation that determines how a value becomes less strong or intense. Therefore, creating the combined anomaly score may include using a dampening function to calculate how quickly each detected anomaly damps out in contributing to the combined anomaly score, and a detected anomaly can be an identification of a value that deviates from what is standard, normal, or expected.

For example, the anomaly scoring system combines the anomaly score of 4.33 for the new value of 0.56% cloud memory utilization at time 9:05 A.M. with the anomaly score of 3.95 for the new value of 0.55% cloud CPU utilization at time 9:05 A.M. First, the anomaly scoring system passes the anomaly score of 4.33 through the sigmoid function to produce the high value of 0.99, because z>=4.33 is very significant. Next, the anomaly scoring system passes the anomaly score of 3.95 through the sigmoid function to produce the high value of 0.98, because z>=3.95 is also very significant. Then the anomaly scoring system adds the value of 0.99 to the value of 0.98 to produce a combined anomaly score of 1.97 for cloud resource utilization at time 9:05 A.M., which may be interpretable as “two time series” are anomalous at about the same time.

If the anomaly scoring system had used the score of 0.81 calculated for the time scale. or lag time, k=1 minute for the difference of 3% between the x values at the times 9:04 A.M. and 9:05 A.M in the time series for cloud memory utilization, combining this score of 0.81 for the time scale, or lag time, k=1 minute for cloud memory utilization with the score of 3.95 for the time scale, or lag time, k=1 minute for cloud CPU utilization would result in the significantly smaller combined anomaly score of 4.76. Therefore, since the two scores that are combined to create the combined anomaly score are based on a time scale score that may have received a contribution from a possible past anomaly, the anomaly scoring system can apply the kernel and sigmoid functions to the anomaly score of 4.33 for cloud memory utilization to determine how quickly any possible anomaly detected between 9:03 A.M. and 9:04 A.M. damps out in its contribution to the anomaly score of 4.33 for cloud memory utilization. This application of the kernel and sigmoid functions also determines how quickly any possible past anomaly for cloud memory utilization between the times 9:03 A.M. and 9:04 A.M. damps out in its contribution to the combined anomaly score of 8.28 for cloud resource utilization. Consequently, the combined anomaly score may be recalculated as an anomaly score between 8.28 and 4.76, based on the dampening by the kernel function and the gain a and offset b chosen for the sigmoid function.

FIG. 2 is an operational flow diagram illustrating a high-level overview of a method 200 for a multi-scale unsupervised anomaly transform for time series data. A machine learning system is optionally trained to calculate at least one training anomaly score for a training set comprising at least some values in a time series, block 202. A machine-learning system can train to calculate anomaly scores for values in time series. For example, and without limitation, this can include a machine learning system using the value of 50% cloud memory utilization at 9:04 A.M. as a training input value. As the previous training 1 lag time values=0.04 and −0.02, the previous training 1 lag time mean=(0.04+−0.02)/2=(0.02)/2=0.01. The previous training 1 lag time standard deviation is calculated by calculating the sum of the square of the differences in the values minus the mean, which is (0.04−0.01)²+(−0.02−0.01)²=(0.03)²+(−0.03)²=0.0009+0.0009=0.0018, calculating the average of this sum, which is 0.0018/2=0.0009, then taking the square root of this average, which is (0.0009)^{(1/2)}=0.03. The machine learning system calculate a training anomaly score for the time scale, or lag time, k=1 minute for the difference 0.04 in the x values at the times t=3 and 4 in a time series by first subtracting 0.01, which is the training set's previous training 1 lag time mean, thereby resulting in the remainder of 0.03. Then the anomaly scoring system divides the remainder of 0.03 by 0.03, which is the training set's previous training 1 lag time standard deviation sₖ, thereby resulting in the 1 lag time score of 1.0 for the training input value of 0.53 at time t=4.

After training to calculate anomaly scores for values in a time series, an input value in the time series is received, block 204. The trained machine-learning system receives a new production value for a time series. By way of example and without limitation, this can include the anomaly scoring system receiving a time series value of 56% cloud memory utilization at 9:05 A.M.

Following receipt of an input value in a time series, a first difference is determined between the input value in the time series, corresponding to an input time, and a first value in the time series, corresponding to the input time minus a first lag, block 206. The trained system calculates the difference between the new value and a previous value in the time series which corresponds to a previous time that lagged the new value's time by a specific amount. In embodiments, this can include the anomaly scoring system calculating a difference of 3% between the 56% cloud memory utilization at 9:05 A.M. and the 53% cloud memory utilization one minute earlier at 9:04 A.M.

Having calculated a first difference between specific values corresponding to times separated by a first lag, a first score is determined based on the first difference and both a first average and a first dispersion corresponding to the first lag and the values in a time series, block 208. The trained system uses the previous mean and standard deviation for differences in time series values separated by a lag time to calculate an anomaly score for the difference for a new time series value separated by the lag time. For example, and without limitation, this can include the anomaly scoring system calculating a 1 time scale, or 1 lag time, score of 0.83 by subtracting the training mean of 1% cloud memory utilization for a 1-minute time scale from the difference of 3% cloud memory utilization, and then dividing the result of 2% cloud memory utilization by the training standard deviation of 2.4% for the 1-minute time scale.

In addition to calculating a first difference between specific values corresponding to times separated by a first lag, a second difference is determined between the input value, corresponding to the input time, and a second value, corresponding to the input time minus a second lag, block 210. The trained system calculates the difference between the new value and a different previous value in the time series which corresponds to a different previous time that lagged the new value's time by a different specific amount. By way of example and without limitation, this can include the anomaly scoring system calculating a difference of 7% between the 56% cloud memory utilization at 9:05 A.M. and the 49% cloud memory utilization two minutes earlier at 9:03 A.M.

After calculating a second difference between specific values corresponding to times separated by a second lag, a second score is determined based on the second difference and both a second average and a second dispersion corresponding to the second lag and the values in a time series, block 212. The trained system uses the previous mean and standard deviation for differences in time series values separated by a different lag time to calculate another anomaly score for the difference for a new time series value separated by the different lag time. In embodiments, this can include the anomaly scoring system calculating a 2 time scales, or 2 lag times, score of 4.33 by subtracting the training mean of 0.5% cloud memory utilization for a 2-minutes time scale from the difference of 7% cloud memory utilization, and then dividing the result of 6.5% cloud memory utilization by the training standard deviation of 1.5% for the 2-minutes time scale.

Following the calculation of first and second scores for an input value, the first score and the second score are transformed into a normalized anomaly score in a time series for normalized anomaly scores, block 214. The system determines which of the time scale scores for an input value is the normalized anomaly score for the input value. For example, and without limitation, this can include the anomaly scoring system calculating the absolute value of every time scale or lag time score for the input value, determining the maximum of the calculated absolute values, and the selecting the time scale or lag time score that corresponds to the maximum of the calculated absolute values as the normalized anomaly score for the input value. In this specific example, the anomaly scoring system calculates the absolute value of the 2 time scale or lag time score of 4.33 for the input value of 56% cloud memory utilization at 9:05 A.M is 4.33, and calculates the absolute value of the 1 time scale or lag time score of 0.83 for the input value of 56% cloud memory utilization at 9:05 A.M is 0.83. Next the anomaly scoring system determines the maximum of the calculated absolute values of 4.33 and 0.83 is 4.33. Then the anomaly scoring system selects the 2 time scale or lag time score of 4.33 that corresponds to 4.33, the maximum of the calculated absolute values, as the normalized anomaly score of 4.33 for the input value of 56% cloud memory utilization at 9:05 A.M. Although the transformation of two positive scores into a normalized anomaly score for an input value is simple in this example, the continuing transformations of a large number of negative and positive scores into a time series of normalized anomaly scores is more complex in real world production environments.

Having determined a normalized anomaly score for an input value, a time series database system stores the time series for normalized anomaly scores and the time series comprising the input value into a time series database, block 216. The system stores the newly generated score time series with the existing input time series. By way of example and without limitation, this can include a time series database system storing a normalized anomaly score time series which includes the value of 4.33 for 9:05 A.M. and corresponds to a cloud memory utilization time series which includes the value of 56% for 9:05 A.M.

After storing the normalized anomaly score time series with the input time series in a time series database, whether the normalized anomaly score satisfies a threshold is determined, block 218. The system determines whether a normalized anomaly score is sufficiently anomalous. In embodiments, this can include the anomaly scoring system determining whether the normalized anomaly score of 4.33 for the 56% cloud memory utilization at 9:05 A.M is greater than the threshold of 3, which represents 3 standard deviations. If the normalized anomaly score satisfies the threshold, the method 200 continues to block 218 to output an anomaly alert. If the normalized anomaly score does not satisfy the threshold, the method 200 terminates for the input value, which enables the processing of another input value in the same or a different time series

In response to a determination that the normalized anomaly score satisfies a threshold, an anomaly alert sis output, the anomaly alert comprising information about the normalized anomaly score and the input value retrieved from the time series database, block 220. The system outputs an anomaly alert that includes a new value in a time series and the normalized anomaly score for the new value. For example, and without limitation, this can include the anomaly scoring system outputting an anomaly alert that includes 4.33, the greatest of the 1 time scale, or 1 lag time, score and the 2 time scale, or 2 lag times, score, as the anomaly score for the 56% cloud memory utilization at 9:05 A.M. Although the increase of 3% cloud memory utilization from 9:04 A.M. to 9:05 A.M. resulted in a score of 0.83 that is not enough to be considered as an anomaly because it does not exceed the user-specified threshold of 3 standard deviations, the increase of 7% cloud memory utilization from 9:03 A.M. to 9:05 A.M. resulted in a score of 4.33 that is enough to be considered as an anomaly because it exceeds the user-specified threshold of 3.5 standard deviations. By calculating the 1 time scale score, the anomaly scoring system can identify anomalies when a value's increase or decrease during a single time scale is sufficient to be more than a user-specified number of deviations from the mean for the value's increases or decreases. By calculating the 2 time scales score, the anomaly scoring system can identify anomalies when a value's collective increase or decrease during two consecutive time scales is sufficient to be more than a user-specified number of deviations from the mean for two consecutive increases or decreases of the value, even if neither of the individual increases or decreases of the value is sufficient to be anomalous for a 1 time scale score.

Having used averages, dispersions, and differences of values in a time series to calculate an anomaly score for an input value in the time series, a machine learning system optionally uses the input value to update the first average, the first dispersion the second average, and/or the second dispersion, block 222. The machine learning system can continuously and incrementally update the means and the standard deviations for the time scales for the values in a time series to enable accurately calculating subsequent time scale and anomaly scores. By way of example and without limitation, this can include the machine-learning system incrementally updating mₖ=mₖ+(x−mₖ)/n.=0.01+(0.03−0.01)/4=0.01+(0.02)/4=0.01+0.005=0.015 as the new mean m₁ and incrementally updating the standard deviation by using the following formula sₖ=(mₖ(x²)−(mₖ)²)=(0.00075−(0.015)²)=(0.00075−0.000225)=(0.000525)^{(1/2)}=0.023.

In addition to creating an anomaly score for an input value at an input time in a time series, a combined anomaly score is optionally created by combining the anomaly score for the input value which corresponds to the input time in the time series with another anomaly score for another input value which corresponds to the input time in another time series, block 224. The system can score a combination of time series to reflect correlated anomalies in the time series. In embodiments, this can include the anomaly scoring system using the sigmoid function to combine the anomaly score of 4.33 for the new value of 0.56% cloud memory utilization at time 9:05 A.M. with an anomaly score of 3.95 for a new value of 0.55% cloud CPU utilization at time 9:05 A.M. to produce a combined anomaly score of 1.97 for cloud resource utilization at time 9:05 A.M., as described above.

The method 200 may be repeated as desired. Although this disclosure describes the blocks 202-218 executing in a particular order, the blocks 202-218 may be executed in a different order. In other implementations, each of the blocks 202-218 may also be executed in combination with other blocks and/or some blocks may be divided into a different set of blocks.

### System Overview

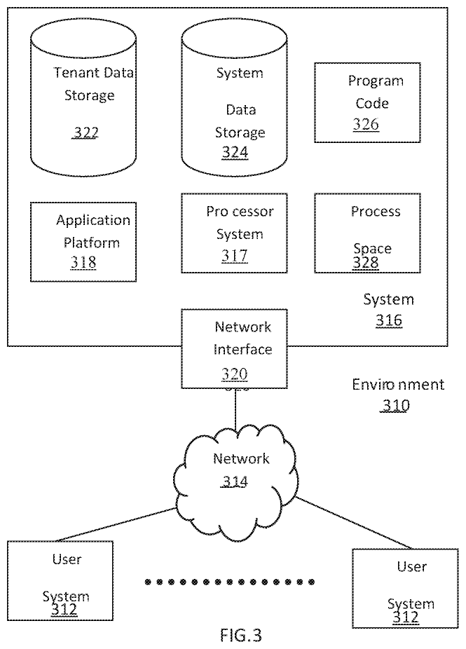

FIG. 3 illustrates a block diagram of an environment 310 wherein an on-demand database service might be used. The environment 310 may include user systems 312, a network 314, a system 316, a processor system 317, an application platform 318, a network interface 320, a tenant data storage 322, a system data storage 324, program code 326, and a process space 328. In other embodiments, the environment 310 may not have all of the components listed and/or may have other elements instead of, or in addition to, those listed above.

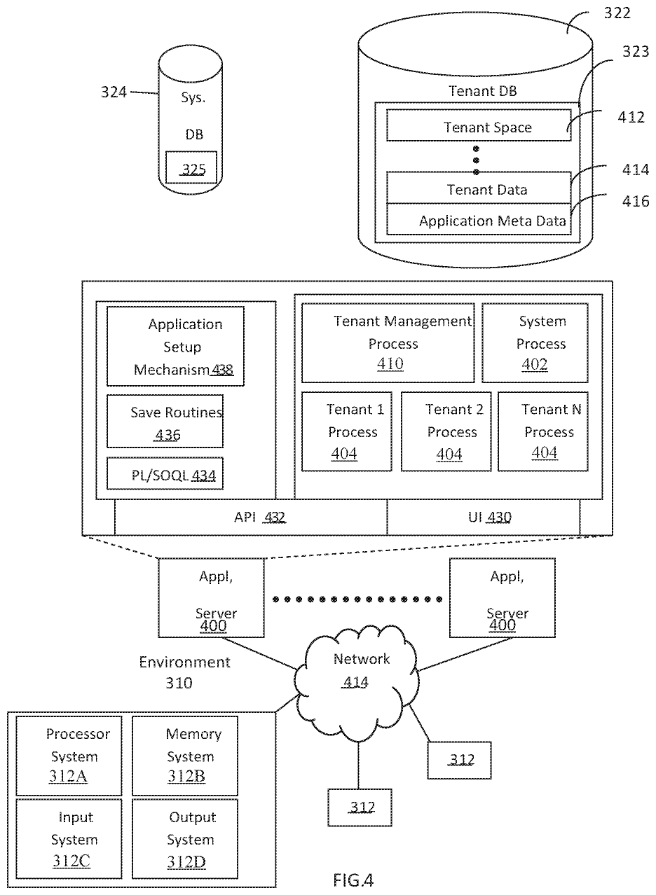

The environment 310 is an environment in which an on-demand database service exists. A user system 312 may be any machine or system that is used by a user to access a database user system. For example, any of the user systems 312 may be a handheld computing device, a mobile phone, a laptop computer, a workstation, and/or a network of computing devices. As illustrated in FIG. 3 (and in more detail in FIG. 4) the user systems 312 might interact via the network 314 with an on-demand database service, which is the system 316.

An on-demand database service, such as the system 316, is a database system that is made available to outside users that do not need to necessarily be concerned with building and/or maintaining the database system, but instead may be available for their use when the users need the database system (e.g., on the demand of the users). Some on-demand database services may store information from one or more tenants stored into tables of a common database image to form a multi-tenant database system (MTS). Accordingly, the “on-demand database service 316” and the “system 316” will be used interchangeably herein. A database image may include one or more database objects. A relational database management system (RDMS) or the equivalent may execute storage and retrieval of information against the database object(s). The application platform 318 may be a framework that allows the applications of the system 316 to run, such as the hardware and/or software, e.g., the operating system. In an embodiment, the on-demand database service 316 may include the application platform 318 which enables creation, managing and executing one or more applications developed by the provider of the on-demand database service, users accessing the on-demand database service via user systems 312, or third party application developers accessing the on-demand database service via the user systems 312.

The users of the user systems 312 may differ in their respective capacities, and the capacity of a particular user system 312 might be entirely determined by permissions (permission levels) for the current user. For example, where a salesperson is using a particular user system 312 to interact with the system 316, that user system 312 has the capacities allotted to that salesperson. However, while an administrator is using that user system 312 to interact with the system 316, that user system 312 has the capacities allotted to that administrator. In systems with a hierarchical role model, users at one permission level may have access to applications, data, and database information accessible by a lower permission level user, but may not have access to certain applications, database information, and data accessible by a user at a higher permission level. Thus, different users will have different capabilities with regard to accessing and modifying application and database information, depending on a user's security or permission level.

The network 314 is any network or combination of networks of devices that communicate with one another. For example, the network 314 may be any one or any combination of a LAN (local area network), WAN (wide area network), telephone network, wireless network, point-to-point network, star network, token ring network, hub network, or other appropriate configuration. As the most common type of computer network in current use is a TCP/IP (Transfer Control Protocol and Internet Protocol) network, such as the global internetwork of networks often referred to as the “Internet” with a capital “I,” that network will be used in many of the examples herein. However, it should be understood that the networks that the one or more implementations might use are not so limited, although TCP/IP is a frequently implemented protocol.

The user systems 312 might communicate with the system 316 using TCP/IP and, at a higher network level, use other common Internet protocols to communicate, such as HTTP, FTP, AFS, WAP, etc. In an example where HTTP is used, the user systems 312 might include an HTTP client commonly referred to as a “browser” for sending and receiving HTTP messages to and from an HTTP server at the system 316. Such an HTTP server might be implemented as the sole network interface between the system 316 and the network 314, but other techniques might be used as well or instead. In some implementations, the interface between the system 316 and the network 314 includes load sharing functionality, such as round-robin HTTP request distributors to balance loads and distribute incoming HTTP requests evenly over a plurality of servers. At least as for the users that are accessing that server, each of the plurality of servers has access to the MTS' data; however, other alternative configurations may be used instead.

In one embodiment, the system 316, shown in FIG. 3, implements a web-based customer relationship management (CRM) system. For example, in one embodiment, the system 316 includes application servers configured to implement and execute CRM software applications as well as provide related data, code, forms, webpages and other information to and from the user systems 312 and to store to, and retrieve from, a database system related data, objects, and Webpage content. With a multi-tenant system, data for multiple tenants may be stored in the same physical database object, however, tenant data typically is arranged so that data of one tenant is kept logically separate from that of other tenants so that one tenant does not have access to another tenant's data, unless such data is expressly shared. In certain embodiments, the system 316 implements applications other than, or in addition to, a CRM application. For example, the system 316 may provide tenant access to multiple hosted (standard and custom) applications, including a CRM application. User (or third party developer) applications, which may or may not include CRM, may be supported by the application platform 318, which manages creation, storage of the applications into one or more database objects and executing of the applications in a virtual machine in the process space of the system 316.

One arrangement for elements of the system 316 is shown in FIG. 3, including the network interface 320, the application platform 318, the tenant data storage 322 for tenant data 323, the system data storage 324 for system data 325 accessible to the system 316 and possibly multiple tenants, the program code 326 for implementing various functions of the system 316, and the process space 328 for executing MTS system processes and tenant-specific processes, such as running applications as part of an application hosting service. Additional processes that may execute on the system 316 include database indexing processes.

Several elements in the system shown in FIG. 3 include conventional, well-known elements that are explained only briefly here. For example, each of the user systems 312 could include a desktop personal computer, workstation, laptop, PDA, cell phone, or any wireless access protocol (WAP) enabled device or any other computing device capable of interfacing directly or indirectly to the Internet or other network connection. Each of the user systems 312 typically runs an HTTP client, e.g., a browsing program, such as Microsoft's Internet Explorer browser, Netscape's Navigator browser, Opera's browser, or a WAP-enabled browser in the case of a cell phone, PDA or other wireless device, or the like, allowing a user (e.g., subscriber of the multi-tenant database system) of the user systems 312 to access, process and view information, pages and applications available to it from the system 316 over the network 314. Each of the user systems 312 also typically includes one or more user interface devices, such as a keyboard, a mouse, trackball, touch pad, touch screen, pen or the like, for interacting with a graphical user interface (GUI) provided by the browser on a display (e.g., a monitor screen, LCD display, etc.) in conjunction with pages, forms, applications and other information provided by the system 316 or other systems or servers. For example, the user interface device may be used to access data and applications hosted by the system 316, and to perform searches on stored data, and otherwise allow a user to interact with various GUI pages that may be presented to a user. As discussed above, embodiments are suitable for use with the Internet, which refers to a specific global internetwork of networks. However, it should be understood that other networks may be used instead of the Internet, such as an intranet, an extranet, a virtual private network (VPN), a non-TCP/IP based network, any LAN or WAN or the like.

According to one embodiment, each of the user systems 312 and all of its components are operator configurable using applications, such as a browser, including computer code run using a central processing unit such as an Intel Pentium® processor or the like. Similarly, the system 316 (and additional instances of an MTS, where more than one is present) and all of their components might be operator configurable using application(s) including computer code to run using a central processing unit such as the processor system 317, which may include an Intel Pentium® processor or the like, and/or multiple processor units. A computer program product embodiment includes a machine-readable storage medium (media) having instructions stored thereon/in which may be used to program a computer to perform any of the processes of the embodiments described herein. Computer code for operating and configuring the system 316 to intercommunicate and to process webpages, applications and other data and media content as described herein are preferably downloaded and stored on a hard disk, but the entire program code, or portions thereof, may also be stored in any other volatile or non-volatile memory medium or device as is well known, such as a ROM or RAM, or provided on any media capable of storing program code, such as any type of rotating media including floppy disks, optical discs, digital versatile disk (DVD), compact disk (CD), micro-drive, and magneto-optical disks, and magnetic or optical cards, nano-systems (including molecular memory ICs), or any type of media or device suitable for storing instructions and/or data. Additionally, the entire program code, or portions thereof, may be transmitted and downloaded from a software source over a transmission medium, e.g., over the Internet, or from another server, as is well known, or transmitted over any other conventional network connection as is well known (e.g., extranet, VPN, LAN, etc.) using any communication medium and protocols (e.g., TCP/IP, HTTP, HTTPS, Ethernet, etc.) as are well known. It will also be appreciated that computer code for implementing embodiments may be implemented in any programming language that may be executed on a client system and/or server or server system such as, for example, C, C++, HTML, any other markup language, Java™, JavaScript, ActiveX, any other scripting language, such as VBScript, and many other programming languages as are well known may be used. (Java™ is a trademark of Sun Microsystems, Inc.).

According to one embodiment, the system 316 is configured to provide webpages, forms, applications, data and media content to the user (client) systems 312 to support the access by the user systems 312 as tenants of the system 316. As such, the system 316 provides security mechanisms to keep each tenant's data separate unless the data is shared. If more than one MTS is used, they may be located in close proximity to one another (e.g., in a server farm located in a single building or campus), or they may be distributed at locations remote from one another (e.g., one or more servers located in city A and one or more servers located in city B). As used herein, each MTS could include one or more logically and/or physically connected servers distributed locally or across one or more geographic locations. Additionally, the term “server” is meant to include a computer system, including processing hardware and process space(s), and an associated storage system and database application (e.g., OODBMS or RDBMS) as is well known in the art. It should also be understood that “server system” and “server” are often used interchangeably herein. Similarly, the database object described herein may be implemented as single databases, a distributed database, a collection of distributed databases, a database with redundant online or offline backups or other redundancies, etc., and might include a distributed database or storage network and associated processing intelligence.

FIG. 4 also illustrates the environment 310. However, in FIG. 4 elements of the system 316 and various interconnections in an embodiment are further illustrated. FIG. 4 shows that the each of the user systems 312 may include a processor system 312A, a memory system 312B, an input system 312C, and an output system 312D. FIG. 4 shows the network 314 and the system 316. FIG. 4 also shows that the system 316 may include the tenant data storage 322, the tenant data 323, the system data storage 324, the system data 325, a User Interface (UI) 430, an Application Program Interface (API) 432, a PL/SOQL 434, save routines 436, an application setup mechanism 438, applications servers 400₁-400_{N}, a system process space 402, tenant process spaces 404, a tenant management process space 410, a tenant storage area 412, a user storage 414, and application metadata 416. In other embodiments, the environment 310 may not have the same elements as those listed above and/or may have other elements instead of, or in addition to, those listed above.

The user systems 312, the network 314, the system 316, the tenant data storage 322, and the system data storage 324 were discussed above in FIG. 3. Regarding the user systems 312, the processor system 312A may be any combination of one or more processors. The memory system 312B may be any combination of one or more memory devices, short term, and/or long term memory. The input system 312C may be any combination of input devices, such as one or more keyboards, mice, trackballs, scanners, cameras, and/or interfaces to networks. The output system 312D may be any combination of output devices, such as one or more monitors, printers, and/or interfaces to networks. As shown by FIG. 4, the system 316 may include the network interface 320 (of FIG. 3) implemented as a set of HTTP application servers 400, the application platform 318, the tenant data storage 322, and the system data storage 324. Also shown is the system process space 402, including individual tenant process spaces 404 and the tenant management process space 410. Each application server 400 may be configured to access tenant data storage 322 and the tenant data 323 therein, and the system data storage 324 and the system data 325 therein to serve requests of the user systems 312. The tenant data 323 might be divided into individual tenant storage areas 412, which may be either a physical arrangement and/or a logical arrangement of data. Within each tenant storage area 412, the user storage 414 and the application metadata 416 might be similarly allocated for each user. For example, a copy of a user's most recently used (MRU) items might be stored to the user storage 414. Similarly, a copy of MRU items for an entire organization that is a tenant might be stored to the tenant storage area 412. The UI 430 provides a user interface and the API 432 provides an application programmer interface to the system 316 resident processes to users and/or developers at the user systems 312. The tenant data and the system data may be stored in various databases, such as one or more Oracle™ databases.

The application platform 318 includes the application setup mechanism 438 that supports application developers' creation and management of applications, which may be saved as metadata into the tenant data storage 322 by the save routines 436 for execution by subscribers as one or more tenant process spaces 404 managed by the tenant management process 410 for example. Invocations to such applications may be coded using the PL/SOQL 434 that provides a programming language style interface extension to the API 432. A detailed description of some PL/SOQL language embodiments is discussed in commonly owned U.S. Pat. No. 7,730,478 entitled, METHOD AND SYSTEM FOR ALLOWING ACCESS TO DEVELOPED APPLICATIONS VIA A MULTI-TENANT ON-DEMAND DATABASE SERVICE, by Craig Weissman, filed Sep. 21, 2007, which is incorporated in its entirety herein for all purposes. Invocations to applications may be detected by one or more system processes, which manages retrieving the application metadata 416 for the subscriber making the invocation and executing the metadata as an application in a virtual machine.

Each application server 400 may be communicably coupled to database systems, e.g., having access to the system data 325 and the tenant data 323, via a different network connection. For example, one application server 400₁ might be coupled via the network 314 (e.g., the Internet), another application server 400_{N-1} might be coupled via a direct network link, and another application server 400_{N} might be coupled by yet a different network connection. Transfer Control Protocol and Internet Protocol (TCP/IP) are typical protocols for communicating between application servers 400 and the database system. However, it will be apparent to one skilled in the art that other transport protocols may be used to optimize the system depending on the network interconnect used.

In certain embodiments, each application server 400 is configured to handle requests for any user associated with any organization that is a tenant. Because it is desirable to be able to add and remove application servers from the server pool at any time for any reason, there is preferably no server affinity for a user and/or organization to a specific application server 400. In one embodiment, therefore, an interface system implementing a load balancing function (e.g., an F5 Big-IP load balancer) is communicably coupled between the application servers 400 and the user systems 312 to distribute requests to the application servers 400. In one embodiment, the load balancer uses a least connections algorithm to route user requests to the application servers 400. Other examples of load balancing algorithms, such as round robin and observed response time, also may be used. For example, in certain embodiments, three consecutive requests from the same user could hit three different application servers 400, and three requests from different users could hit the same application server 400. In this manner, the system 316 is multi-tenant, wherein the system 316 handles storage of, and access to, different objects, data and applications across disparate users and organizations.

As an example of storage, one tenant might be a company that employs a sales force where each salesperson uses the system 316 to manage their sales process. Thus, a user might maintain contact data, leads data, customer follow-up data, performance data, goals and progress data, etc., all applicable to that user's personal sales process (e.g., in the tenant data storage 322). In an example of a MTS arrangement, since all of the data and the applications to access, view, modify, report, transmit, calculate, etc., may be maintained and accessed by a user system having nothing more than network access, the user can manage his or her sales efforts and cycles from any of many different user systems. For example, if a salesperson is visiting a customer and the customer has Internet access in their lobby, the salesperson can obtain critical updates as to that customer while waiting for the customer to arrive in the lobby.

While each user's data might be separate from other users' data regardless of the employers of each user, some data might be organization-wide data shared or accessible by a plurality of users or all of the users for a given organization that is a tenant. Thus, there might be some data structures managed by the system 316 that are allocated at the tenant level while other data structures might be managed at the user level. Because an MTS might support multiple tenants including possible competitors, the MTS should have security protocols that keep data, applications, and application use separate. Also, because many tenants may opt for access to an MTS rather than maintain their own system, redundancy, up-time, and backup are additional functions that may be implemented in the MTS. In addition to user-specific data and tenant specific data, the system 316 might also maintain system level data usable by multiple tenants or other data. Such system level data might include industry reports, news, postings, and the like that are sharable among tenants.

In certain embodiments, the user systems 312 (which may be client systems) communicate with the application servers 400 to request and update system-level and tenant-level data from the system 316 that may require sending one or more queries to the tenant data storage 322 and/or the system data storage 324. The system 316 (e.g., an application server 400 in the system 316) automatically generates one or more SQL statements (e.g., one or more SQL queries) that are designed to access the desired information. The system data storage 324 may generate query plans to access the requested data from the database.

Each database can generally be viewed as a collection of objects, such as a set of logical tables, containing data fitted into predefined categories. A “table” is one representation of a data object, and may be used herein to simplify the conceptual description of objects and custom objects. It should be understood that “table” and “object” may be used interchangeably herein. Each table generally contains one or more data categories logically arranged as columns or fields in a viewable schema. Each row or record of a table contains an instance of data for each category defined by the fields. For example, a CRM database may include a table that describes a customer with fields for basic contact information such as name, address, phone number, fax number, etc. Another table might describe a purchase order, including fields for information such as customer, product, sale price, date, etc. In some multi-tenant database systems, standard entity tables might be provided for use by all tenants. For CRM database applications, such standard entities might include tables for Account, Contact, Lead, and Opportunity data, each containing pre-defined fields. It should be understood that the word “entity” may also be used interchangeably herein with “object” and “table”.

In some multi-tenant database systems, tenants may be allowed to create and store custom objects, or they may be allowed to customize standard entities or objects, for example by creating custom fields for standard objects, including custom index fields. U.S. Pat. No. 7,779,039, filed Apr. 2, 2004, entitled “Custom Entities and Fields in a Multi-Tenant Database System”, which is hereby incorporated herein by reference, teaches systems and methods for creating custom objects as well as customizing standard objects in a multi-tenant database system. In certain embodiments, for example, all custom entity data rows are stored in a single multi-tenant physical table, which may contain multiple logical tables per organization. It is transparent to customers that their multiple “tables” are in fact stored in one large table or that their data may be stored in the same table as the data of other customers.

While one or more implementations have been described by way of example and in terms of the specific embodiments, it is to be understood that one or more implementations are not limited to the disclosed embodiments. To the contrary, it is intended to cover various modifications and similar arrangements as would be apparent to those skilled in the art. Therefore, the scope of the appended claims should be accorded the broadest interpretation so as to encompass all such modifications and similar arrangements.

1. A system for a multi-scale unsupervised anomaly transform for time series data, the system comprising:
one or more processors; and
a non-transitory computer readable medium storing a plurality of instructions, which when executed, cause the one or more processors to:
determine a first difference between an input value, of values in a time series, corresponding to an input time, and a first value, of the values, corresponding to the input time minus a first lag, in response to receiving the input value;
determine a first score based on the first difference and both a first average and a first dispersion corresponding to the first lag and the values;
determine a second difference between the input value, corresponding to the input time, and a second value, of the values, corresponding to the input time minus a second lag;
determine a second score based on the second difference and both a second average and a second dispersion corresponding to the second lag and the values;
transform the first score and the second score into a normalized anomaly score in a time series for normalized anomaly scores;
store, by a time series database system, the time series for normalized anomaly scores and the time series comprising the input value into a time series database; and
cause an anomaly alert comprising information about the normalized anomaly score and the input value retrieved from the time series database to be outputted, in response to a determination that the normalized anomaly score satisfies a threshold.

2. The system of claim 1, wherein the plurality of instructions further causes the processor to train a machine learning system to calculate at least one training anomaly score for a training set comprising at least some of the values in the time series.

3. The system of claim 2, wherein at least some values in the training set are regularized by additions of corresponding independent random variables and multiplications based on other corresponding independent random variables.

4. The system of claim 1, wherein the plurality of instructions further causes the processor to update, by a machine learning system, using the input value, at least one of the first average, the first dispersion the second average, and the second dispersion.

5. The system of claim 4, wherein updating the first average and the first dispersion is in response to a determination that the first difference is within a number of the first dispersions of the first average, and updating the second average and the second dispersion is in response to a determination that the second difference is within a number of the second dispersions of the second average.

6. The system of claim 1, wherein the plurality of instructions further causes the processor to create a combined anomaly score by combining the anomaly score for the input value which corresponds to the input time in the time series with another anomaly score for another input value which corresponds to the input time in another time series.

7. The system of claim 6, wherein creating the combined anomaly score comprises using a dampening function to determine how quickly each detected anomaly damps out in contributing to the combined anomaly score.

8. A computer program product comprising computer-readable program code to be executed by one or more processors when retrieved from a non-transitory computer-readable medium, the program code including instructions to:
determine a first difference between an input value, of values in a time series, corresponding to an input time, and a first value, of the values, corresponding to the input time minus a first lag, in response to receiving the input value;
determine a first score based on the first difference and both a first average and a first dispersion corresponding to the first lag and the values;
determine a second difference between the input value, corresponding to the input time, and a second value, of the values, corresponding to the input time minus a second lag;
determine a second score based on the second difference and both a second average and a second dispersion corresponding to the second lag and the values;
transform the first score and the second score into a normalized anomaly score in a time series for normalized anomaly scores;
store, by a time series database system, the time series for normalized anomaly scores and the time series comprising the input value into a time series database; and
cause an anomaly alert comprising information about the normalized anomaly score and the input value retrieved from the time series database to be outputted, in response to a determination that the normalized anomaly score satisfies a threshold.

9. The computer program product of claim 8, wherein the program code includes further instructions to train a machine learning system to calculate at least one training anomaly score for a training set comprising at least some of the values in the time series.

10. The computer program product of claim 9, wherein at least some values in the training set are regularized by additions of corresponding independent random variables and multiplications based on other corresponding independent random variables.

11. The computer program product of claim 8, wherein the program code includes further instructions to update, by a machine learning system, using the input value, at least one of the first average, the first dispersion the second average, and the second dispersion.

12. The computer program product of claim 11, wherein updating the first average and the first dispersion is in response to a determination that the first difference is within a number of the first dispersions of the first average, and updating the second average and the second dispersion is in response to a determination that the second difference is within a number of the second dispersions of the second average.

13. The computer program product of claim 8, wherein the program code includes further instructions to create a combined anomaly score by combining the anomaly score for the input value which corresponds to the input time in the time series with another anomaly score for another input value which corresponds to the input time in another time series.

14. The computer program product of claim 13, wherein creating the combined anomaly score comprises using a dampening function to determine how quickly each detected anomaly damps out in contributing to the combined anomaly score.

15. A computer-implemented method for a multi-scale unsupervised anomaly transform for time series data, the computer-implemented method comprising:
determining a first difference between an input value, of values in a time series, corresponding to an input time, and a first value, of the values, corresponding to the input time minus a first lag, in response to receiving the input value;
determining a first score based on the first difference and both a first average and a first dispersion corresponding to the first lag and the values;
determining a second difference between the input value, corresponding to the input time, and a second value, of the values, corresponding to the input time minus a second lag;
determining a second score based on the second difference and both a second average and a second dispersion corresponding to the second lag and the values;
transforming the first score and the second score into a normalized anomaly score in a time series for normalized anomaly scores;
storing, by a time series database system, the time series for normalized anomaly scores and the time series comprising the input value into a time series database; and
causing an anomaly alert comprising information about the normalized anomaly score and the input value retrieved from the time series database to be outputted, in response to a determination that the normalized anomaly score satisfies a threshold.

16. The computer-implemented method of claim 15, wherein the computer-implemented method further comprises training a machine learning system to calculate at least one training anomaly score for a training set comprising at least some of the values in the time series.

17. The computer-implemented method of claim 16, wherein at least some values in the training set are regularized by additions of corresponding independent random variables and multiplications based on other corresponding independent random variables.

18. The computer-implemented method of claim 15, wherein the computer-implemented method further comprises updating, by a machine learning system, using the input value, at least one of the first average, the first dispersion the second average, and the second dispersion.

19. The computer-implemented method of claim 18, wherein updating the first average and the first dispersion is in response to a determination that the first difference is within a number of the first dispersions of the first average, and updating the second average and the second dispersion is in response to a determination that the second difference is within a number of the second dispersions of the second average.

20. The computer-implemented method of claim 15, wherein the computer-implemented method further comprises creating a combined anomaly score by combining the anomaly score for the input value which corresponds to the input time in the time series with another anomaly score for another input value which corresponds to the input time in another time series, wherein creating the combined anomaly score comprises using a dampening function to determine how quickly each detected anomaly damps out in contributing to the combined anomaly score.
